(19) United States
(12) Patent Application Publication
(10) Pub. No.: US 2011/0023313 A1
(43) Pub. Date: Feb. 3, 2011

(54) HANGER LOCATOR

(76) Inventors: Natalia Johnson, Statesville, NC (US); Christian Scott Leyden, Cornelius, NC (US); Robin E. Smith, Stanley, NC (US); Jackie Grant, Charlotte, NC (US)

Correspondence Address: TAFT, STETTINIUS & HOLLISTER LLP, SUITE 1800, 425 WALNUT STREET, CINCINNATI, OH, 45202-3957, US

(21) Appl. No.: 12/511,319

(22) Filed: Jul. 29, 2009

(51) Int. Cl. B25H 7/00

(52) U.S. Cl. 33/666

(57) ABSTRACT

A hanger locator for identifying the proper location for a hanger on a wall may include a first arm and a second arm extending from a central body. The central body may include a marker and/or a hook for engaging a suspension device. In some exemplary embodiments, the arms may include elastic bands. In some exemplary embodiments, the arms may include cords, and the central body may include a retractor coupled to the cords.

### BACKGROUND

The present disclosure is directed to wall-marking devices and, more particularly, to wall-marking devices which facilitate marking a wall at a location where a hanger for a wall-mounted article will be affixed.

### SUMMARY

Exemplary embodiments according to the present disclosure may include a hanger locator for identifying the proper location for a hanger on a wall and may include a first arm and a second arm extending from a central body. The central body may include a marker and/or a hook for engaging a suspension device. In some exemplary embodiments, the arms may include elastic bands. In some exemplary embodiments, the arms may include cords, and the central body may include a retractor coupled to the cords.

In an aspect, a hanger locator may include a central body; at least two arms extending from the central body for engaging corners of an article; a hook mounted to the central body for engaging a suspension device of the article; and a marker mounted to the central body.

In a detailed embodiment, each of the at least two arms may include a substantially elastic band. In a detailed embodiment, each of the at least two arms may include a corner catch for releasably engaging a respective one of the corners of the article. In a detailed embodiment, each of the corner catches may be releasably coupled to a respective one of the elastic bands by a clip. In a detailed embodiment, the elastic band may include a plurality of holes for receiving the clip.

In a detailed embodiment, the marker may include an indenter for marking a surface. In a detailed embodiment, the marker may include graphite to be deposited on a wall.

In a detailed embodiment, each of the at least two arms may include a substantially inelastic cord, and the central body may include at least one retractor arranged for retraction of the cord. In a detailed embodiment, the retractor may include a bobbin for winding the cords, and the retractor may include a constant force spring coupled to the bobbin and arranged to oppose extension of the cords. In a detailed embodiment, a hanger locator may include a button selectively engageable with the retractor, the button being operative to prevent rotation of the retractor in a first position and allowing rotation of the retractor in a second position.

In an aspect, a hanger locator may include a central body including a hook on a first side and a marker on a second side; a first arm extending from the central body, the first arm including a first elastic band and a first corner catch; and a second arm extending from the central body, the second arm including a second elastic band and a second corner catch.

In a detailed embodiment, the first corner catch may be releasably coupled to the first elastic band by a first clip, and the second corner catch may be releasably coupled to the second elastic bands by a second clip. In a detailed embodiment, each of the first elastic band and the elastic band may include a plurality of holes for receiving the first clip and the second clip, respectively.

In a detailed embodiment, the marker may include an indenter for marking a surface. In a detailed embodiment, the marker may include graphite to be deposited on a wall. In a detailed embodiment, each of the first corner catch and the second corner catch may include a fabric corner. In a detailed embodiment, each of the fabric corners may include an eyelet for receiving a clip.

In an aspect, a method of identifying a location for a hanger on a wall may include mounting a hanger locator to an article to be suspended from a wall by engaging a first arm of the hanger locator with a first corner of the article, engaging a second arm of the hanger locator with a second corner of the article, and engaging a central body of the hanger locator with a suspension device of the article, the first arm and the second arm extending from the central body; placing the article proximate a desired position; and marking the wall using a marker affixed to the central body.

In a detailed embodiment, each of the first arm and the second arm may include an elastic band, engaging the first arm of the hanger locator with the first corner may include elastically extending the elastic band of the first arm, and engaging the second arm of the hanger locator with the second corner may include elastically extending the elastic band of the second arm. In a detailed embodiment, marking the wall may include at least one of indenting the wall and depositing graphite on the wall.

### BRIEF DESCRIPTION OF THE DRAWINGS

The detailed description refers to the following figures in which:

FIG. 1 is an exploded perspective view of an exemplary hanger locator;

FIG. 2 is a front elevation view of an exemplary hanger locator installed on a picture frame;

FIG. 3 is a side elevation view of an exemplary cover for a central body;

FIG. 4 is rear elevation view of an exemplary central body base;

FIG. 5 is a cross-sectional view of an exemplary central body base;

FIG. 6 is a perspective view of an exemplary central body base;

FIG. 7 is an exploded perspective view of an alternative exemplary hanger locator; and

FIG. 8 is a cross-sectional view of an alternative exemplary hanger locator all in accordance with at least some aspects of this disclosure.

### DETAILED DESCRIPTION

The present disclosure contemplates that articles, such as picture frames, may be suspended from walls. In some circumstances, a picture hanger may be mounted to a wall, and a suspension device, such as a picture wire, attached to the picture frame may be engaged with the picture hanger to suspend the picture frame from the wall.

In addition, the present disclosure contemplates that it may be difficult to identify the correct location for a picture hanger on a wall. In particular, even when the desired position of the picture frame has been determined, it may be difficult to identify the proper location for the picture hanger because the suspension device may be very close to the back of the picture frame and it may be difficult to ascertain the position of the picture wire when the picture frame is held against the wall.

Exemplary hanger locators according to at least some aspects of the present disclosure may assist in identifying the proper location for a picture hanger by marking the wall while the picture frame is held in the desired position. For example, an exemplary hanger locator may be temporarily installed on a picture frame and may be used to mark the proper location for a picture hanger on a wall.

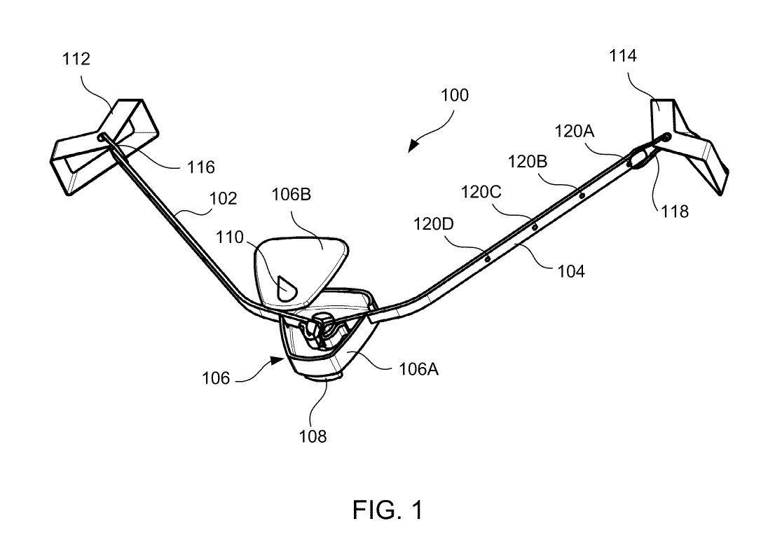

Some exemplary hanger locators may include two or more arms for engaging the corners of an article, such as a picture frame. The arms may extend from a central body, which may include at least one hook for engaging the picture frame's suspension device, such as a picture wire. The central body may include a marking device, such as an indenter. For example, as shown in FIG. 1, an exemplary hanger locator 100 may include at least two flexible arms comprising elastic bands 102, 104 extending from a central body 106. Central body 106 may include a base 106A including a hook 108 and/or a cover 1068 including a marking device, such as an indenter 110. Corner catches, such as fabric corners 112, 114, may be releasably coupled to the elastic bands 102, 104 by clips 116, 118, respectively. Clip 118 may engage elastic band 104 at any of holes 120A, 120B, 120C, 120D to allow adjustment for different frame sizes, and elastic band 102 may include corresponding features for adjustability.

In an exemplary embodiment, central body 106 may be about 1.6 inches high, about 1.75 inches wide, and/or about 0.5 inches thick. In an exemplary embodiment, each elastic band 102, 104 may be about 7.25 inches long and about 0.25 inches wide.

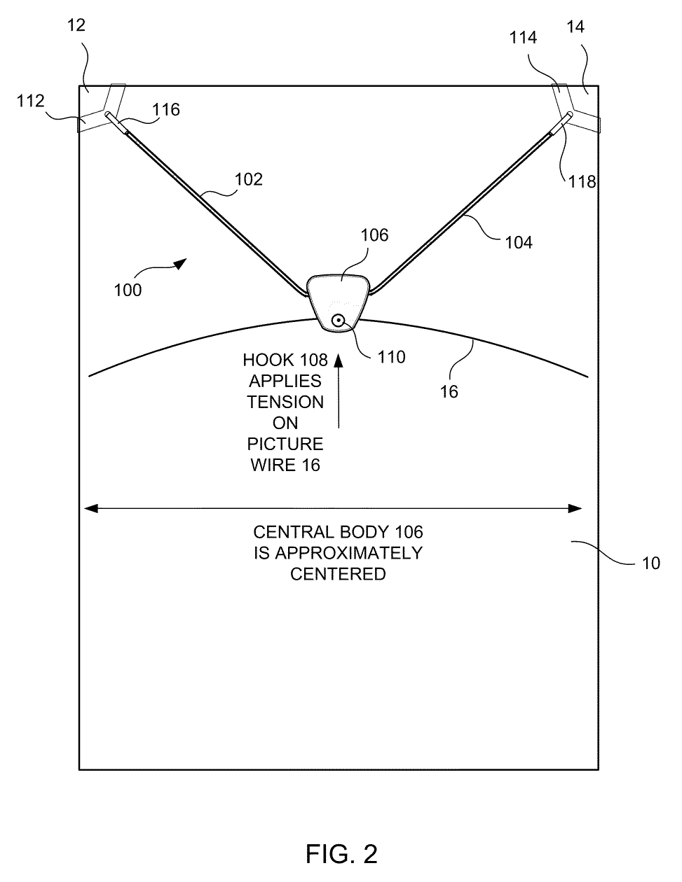

Referring to FIG. 2, an exemplary hanger locator 100 may be installed on an article to be hung on a wall, such as a picture frame 10. Corner catches, such as fabric corners 112, 114 may be placed over the edges of the frame 10 proximate upper corners 12, 14, respectively, and the hook 108 may engage the picture wire 16. Elastic bands 102, 104 may be elastically extended to permit fabric corners 112, 114 to engage the frame 10 and to permit hook 108 to engage the picture wire 16. The elastic bands 102, 104 may be of substantially the same length and/or may be of substantially the same elasticity, which may bias the central body to a position approximately centered between the picture frame corners 12, 14. Hook 108 may apply tension to the picture wire 16 in generally the same direction as the picture wire 16 will experience when the frame 10 is hung on the wall. Thus, indenter 110 may be positioned on the frame 10 at approximately the same relative position as a hanger. Thus, the frame 10, with an exemplary hanger locator 100 installed, may be held in its desired position in front of a wall, and the indenter 110 may be used to mark the wall in the approximate location for a hanger.

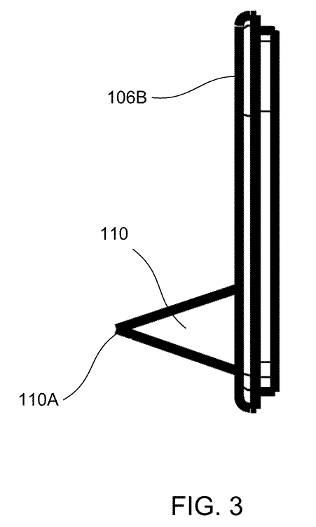

Referring to FIG. 3, an exemplary indenter 110 may project outwardly from cover 106B. The indenter 110 may be generally conically shaped and/or may have a substantially pointed end 110A. An exemplary indenter 110 may project outwardly about 0.5 inches from the central body 106.

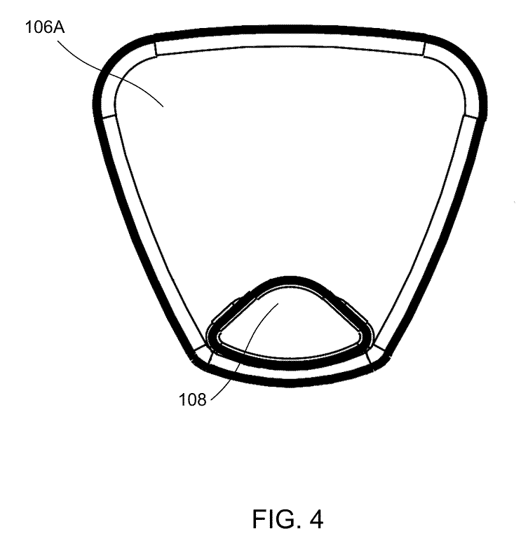

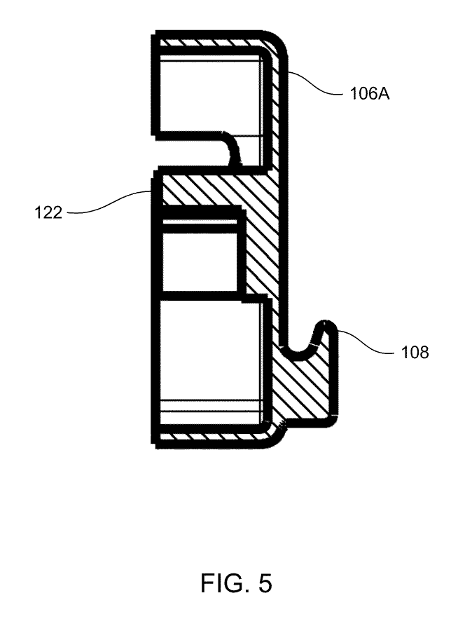

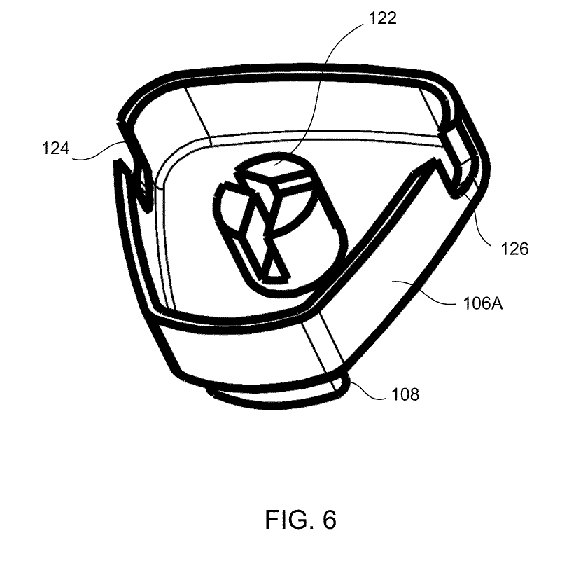

Referring to FIGS. 4-6, an exemplary central body base 106A may include an outwardly extending hook 108 for engaging a picture wire 16. Base 106A may include one or more structures for coupling to elastic bands 102, 104, such as post 122. Base 106A may include one or more openings, such as slots 124, 126, to allow elastic bands 102, 104 to extend from post 122 to the exterior of the central body 106.

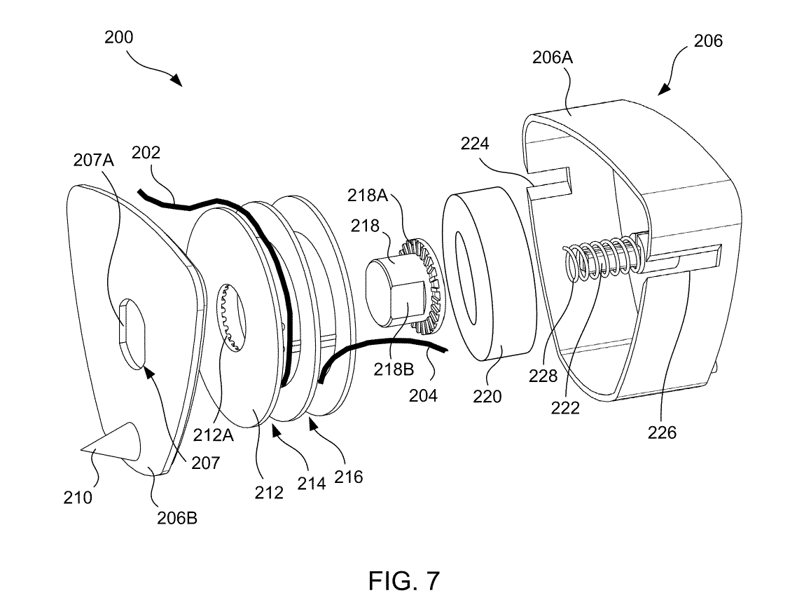

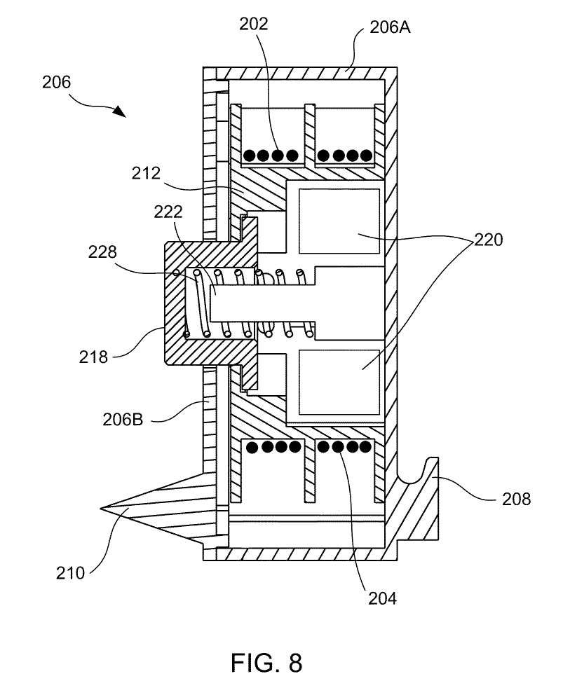

Referring to FIGS. 7 and 8, an alternative exemplary hanger locator may include one or more flexible arms comprising cords 202, 204. Cords 202, 204 may be coupled to corner catches (such as fabric corner 112, 114) and/or any other devices for engaging an article, such as a picture frame. An exemplary central body 206 may include a bobbin 212, which may include reels 214, 216 for winding cords 202, 204, respectively. Teeth 212A may be arranged to selectively engage teeth 218A of button 218 when the button is in an extended position. Button 218 may extend through hole 207 of cover 206B (which may include indenter 210), and flats 207A of hole 207 may receive flats 218B of button 218, thus preventing rotation of button 218. Accordingly, when button 218 is in its extended position and teeth 218A engage teeth 212A, rotation of bobbin 212 may be prevented. Bobbin 212 may be biased by a spring, such as constant force spring 220. In an exemplary embodiment, constant force spring 220 is arranged to bias bobbin 212 in the wind direction, such that cords 202, 204 are wound onto reels 214, 216 when button 218 is depressed and teeth 218A disengage from teeth 212A. Base 206A may include a post 222 on which constant force spring 220, button 218, and/or bobbin 212 may be mounted. Helical compression spring 228 may be mounted on post 222 to bias button 218 into its extended position. Cords 202, 204 may be extended from or retracted onto bobbin 212 via slots 224, 226, respectively, by depressing button 218. Cords 202, 204 may be of about equal lengths, and bobbin 212 may dispense cords 202, 204 at about the same rate. Thus, central body 206 may be positioned at approximately a midpoint between the ends of cords 202, 204. Accordingly, when installed on an article such as picture frame 10, indenter 210 may be located at about the proper relative position for a picture hanger. In an exemplary embodiment, cords 202, 204 may be about 36 inches in length. In some exemplary embodiments, button 218 and the associated teeth 218A, 212A may be omitted, and constant force spring 220 may constantly apply tension forces on cords 202, 204 via bobbin 212.

In some exemplary embodiments, elastic bands 102, 104 may be constructed from silicone rubber of 60-70 A durometer with an elongation rate of 300-400%. In some exemplary embodiments, clips 116, 118 may be constructed from plastic and/or metal, such as zinc-plated steel. In some exemplary embodiments, fabric corners 112, 114 may be constructed from a substantially non-stretching fabric and/or may include reinforcing eyelets and/or grommets for coupling with clips 116, 118. In some exemplary embodiments, the central body 106, 206 may be constructed of plastic, such as polypropylene, which may be glass filled. In some exemplary embodiments cords 202, 204 may be constructed from nylon twine. In some exemplary embodiments, the marking device may include a graphite marker or the like in addition to or in place of an indenter.

Although the exemplary embodiments discussed herein have been described in connection with picture frames, picture wires, and picture hangers, exemplary hanger locators may be utilized with any articles including suspension devices. For example, photographs, paintings, posters, cork boards, mirrors, framed certificates, framed licenses, shadow boxes, and the like may be mounted to walls using suspension devices. Accordingly, as used herein, “article” refers to any such object that may be suspended from wall. In addition, exemplary hanger locators may be utilized with any type of suspension device. For example, in addition to picture wires, exemplary suspension devices include cords, sawtooth hangers, rings, slots, and the like. Further, exemplary hanger locators may be used in connection with hangers other than picture hangers. For example, exemplary hanger locators may be used to properly position nails, screws, hooks, brackets, and the like.

An exemplary hanger locator may be utilized as follows. The hanger locator may be installed on a picture frame (or other article) by attaching the arms to the upper corners of the article and by engaging the hook on the central body with the article's suspension device. The article may be held near the wall to which it will be mounted, and the marking device may be used to create a mark on the wall at the position where a hanger should be mounted. A hanger may be mounted to the wall, and the hanger locator may be removed from the picture frame. The picture frame may be suspended from the wall using the hanger.

Some exemplary embodiments may be utilized with some suspension devices in a similar manner, except that the corner catches may be installed on the bottom corners of the article and the hook may be placed on top of the suspension device. This method may be use, for example, with sawtooth picture hangers or other suspension devices that are located near the top edge of a frame. When utilized with suspension devices located near the top edge of a frame, attaching the corner catches to the bottom corners of the article may be more secure due to the relative angles of the arms with the central body. Instead of extending substantially horizontally to the upper corners, the arms my extend diagonally downward, thus more securely holding the hook against the suspension device.

While exemplary embodiments have been set forth above for the purpose of disclosure, modifications of the disclosed embodiments as well as other embodiments thereof may occur to those skilled in the art. Accordingly, it is to be understood that the disclosure is not limited to the above precise embodiments and that changes may be made without departing from the scope. Likewise, it is to be understood that it is not necessary to meet any or all of the stated advantages or objects disclosed herein to fall within the scope of the disclosure, since inherent and/or unforeseen advantages may exist even though they may not have been explicitly discussed herein.

What is claimed is:

1. A hanger locator comprising:
a central body;
at least two arms extending from the central body for engaging corners of an article;
a hook mounted to the central body for engaging a suspension device of the article; and
a marker mounted to the central body.

2. The hanger locator of claim 1, wherein each of the at least two arms includes a substantially elastic band.

3. The hanger locator of claim 2, wherein each of the at least two arms includes a corner catch for releasably engaging a respective one of the corners of the article.

4. The hanger locator of claim 3, wherein each of the corner catches is releasably coupled to a respective one of the elastic bands by a clip.

5. The hanger locator of claim 4, wherein the elastic band include a plurality of holes for receiving the clip.

6. The hanger locator of claim 1, wherein the marker includes an indenter for marking a surface.

7. The hanger locator of claim 1, wherein the marker includes graphite to be deposited on a wall.

8. The hanger locator of claim 1, wherein each of the at least two arms includes a substantially inelastic cord; and wherein the central body includes at least one retractor arranged for retraction of the cord.

9. The hanger locator of claim 8, wherein the retractor includes a bobbin for winding the cords; and wherein the retractor includes a constant force spring coupled to the bobbin and arranged to oppose extension of the cords.

10. The hanger locator of claim 8, further comprising a button selectively engageable with the retractor, the button being operative to prevent rotation of the retractor in a first position and allowing rotation of the retractor in a second position.

11. A hanger locator comprising:
a central body including a hook on a first side and a marker on a second side;
a first arm extending from the central body, the first arm including a first elastic band and a first corner catch; and
a second arm extending from the central body, the second arm including a second elastic band and a second corner catch.

12. The hanger locator of claim 10, wherein the first corner catch is releasably coupled to the first elastic band by a first clip; and wherein the second corner catch is releasably coupled to the second elastic bands by a second clip.

13. The hanger locator of claim 11, wherein each of the first elastic band and the elastic band include a plurality of holes for receiving the first clip and the second clip, respectively.

14. The hanger locator of claim 10, wherein the marker includes an indenter for marking a surface.

15. The hanger locator of claim 10, wherein the marker includes graphite to be deposited on a wall.

16. The hanger locator of claim 10, wherein each of the first corner catch and the second corner catch includes a fabric corner.

17. The hanger locator of claim 16, wherein each of the fabric corners includes an eyelet for receiving a clip.

18. A method of identifying a location for a hanger on a wall, the method comprising:
mounting a hanger locator to an article to be suspended from a wall by
engaging a first arm of the hanger locator with a first corner of the article,
engaging a second arm of the hanger locator with a second corner of the article, and
engaging a central body of the hanger locator with a suspension device of the article, the first arm and the second arm extending from the central body;
placing the article proximate a desired position; and
marking the wall using a marker affixed to the central body.

19. The method of claim 18, wherein each of the first arm and the second arm includes an elastic band; wherein engaging the first arm of the hanger locator with the first corner includes elastically extending the elastic band of the first arm; and wherein engaging the second arm of the hanger locator with the second corner includes elastically extending the elastic band of the second arm.

20. The method of claim 18, wherein marking the wall includes at least one of indenting the wall and depositing graphite on the wall.
